(19) United States
(12) Patent Application Publication
(10) Pub. No.: US 2011/0054685 A1
(43) Pub. Date: Mar. 3, 2011

(54) ROBOT OFF-LINE TEACHING METHOD

(75) Inventor: Hiroaki WADA, Tochigi (JP)

(73) Assignee: HONDA MOTOR CO., LTD., Tokyo (JP)

(21) Appl. No.: 12/842,635

(22) Filed: Jul. 23, 2010

(30) Foreign Application Priority Data
Aug. 27, 2009 (JP) P2009-196418

(51) Int. Cl. G05B 19/04

(52) U.S. Cl. 700/252

(57) ABSTRACT

According to one embodiment, a robot off-line teaching method includes: setting a plurality of virtual teaching points; setting a posture of the virtual tool on a part of the virtual teaching points which include a start point and an end point; executing an interpolating operation between the part of the virtual teaching points; storing a position and a posture of the virtual tool in the execution of the interpolating operation as an interpolating operation point every predetermined interval; selecting any of the stored interpolating operation points which satisfies a predetermined selection criterion every other virtual teaching points; and reading posture data on the selected interpolating operation point and storing the read posture data as posture data on the other virtual teaching points every other virtual teaching points.

### CROSS-REFERENCE TO RELATED APPLICATION

This application is based on and claims priority under 35 U.S.C. §119 from Japanese Patent Application No. 2009-196418 filed on Aug. 27, 2009, the entire contents of which are incorporated herein by reference.

### BACKGROUND

1. Field

The present invention relates to a robot off-line teaching method.

2. Description of the Related Art

Recently, there is known an off-line teaching method (off-line teaching) of building models of a three-dimensional articulated robot, a tool to be attached to a tip of the articulated robot, and a workpiece to be a working target and a peripheral structure on a virtual space through a computer and creating teaching data for the articulated robot by using the models, and then supplying the teaching data to the articulated robot on a spot (for example, see JP-A-2008-33419). Consequently, it is not necessary to stop a manufacturing line during the creation of the teaching data and it is possible to enhance an operating rate of the manufacturing line.

### SUMMARY

Teaching data are constituted by a plurality of teaching points. The teaching point includes information about a position and a posture of a tool. Conventionally, it is necessary to manually set the position and the posture at all of the teaching points, and a great deal of time is required for creating the teaching data.

It is an object of the invention to provide a robot off-line teaching method which can easily create teaching data.

According to a first aspect of the invention, there is provided a robot off-line teaching method including:

setting a plurality of virtual teaching points at an interval from each other in order to teach a moving path and a posture of a virtual tool attached to a virtual robot in a manufacturing line on a virtual space;

setting a posture of the virtual tool on a part of the virtual teaching points which include at least a start point and an end point, respectively;

executing an interpolating operation between the part of the virtual teaching points in order to sequentially connect the part of the virtual teaching points from the start point to the end point and to take the posture of the virtual tool set at the part of the virtual teaching points, respectively;

storing a position and a posture of the virtual tool in the execution of the interpolating operation as an interpolating operation point every predetermined interval;

selecting any of the stored interpolating operation points which satisfies a predetermined selection criterion every other virtual teaching points excluding the part of the virtual teaching points; and

reading posture data on the selected interpolating operation point and storing the read posture data as posture data on the other virtual teaching points every other virtual teaching points.

According to a second aspect of the invention, there is provided the robot off-line teaching method according to the first aspect, wherein

the predetermined selection criterion is the interpolating operation point positioned at a minimum distance from the other virtual teaching points.

As a predetermined selection criterion according to the invention, for example, it is possible to set an interpolating operation point which is positioned at the smallest distance from the other virtual teaching points.

### BRIEF DESCRIPTION OF THE DRAWINGS

A general architecture that implements the various features of the invention will now be described with reference to the drawings. The drawings and the associated descriptions are provided to illustrate embodiments of the invention and not limited the scope of the invention.

FIG. 1 is an explanatory block diagram showing a structure of a robot teaching CAD device using an embodiment of a robot off-line teaching method according to the invention;

FIG. 2 is an explanatory diagram showing an interference confirmation dialog box of the robot teaching CAD device according to the embodiment;

FIG. 3 is an explanatory diagram showing an interference result dialog box of the robot teaching CAD device according to the embodiment;

FIG. 4 is an explanatory flowchart showing a procedure for a teaching method of the robot teaching CAD device according to the embodiment; and

FIG. 5 is an explanatory view showing an example of a virtual teaching point of the robot teaching CAD device according to the embodiment.

### DETAILED DESCRIPTION

Various embodiments according to the invention will be described hereinafter with reference to the accompanying drawings.

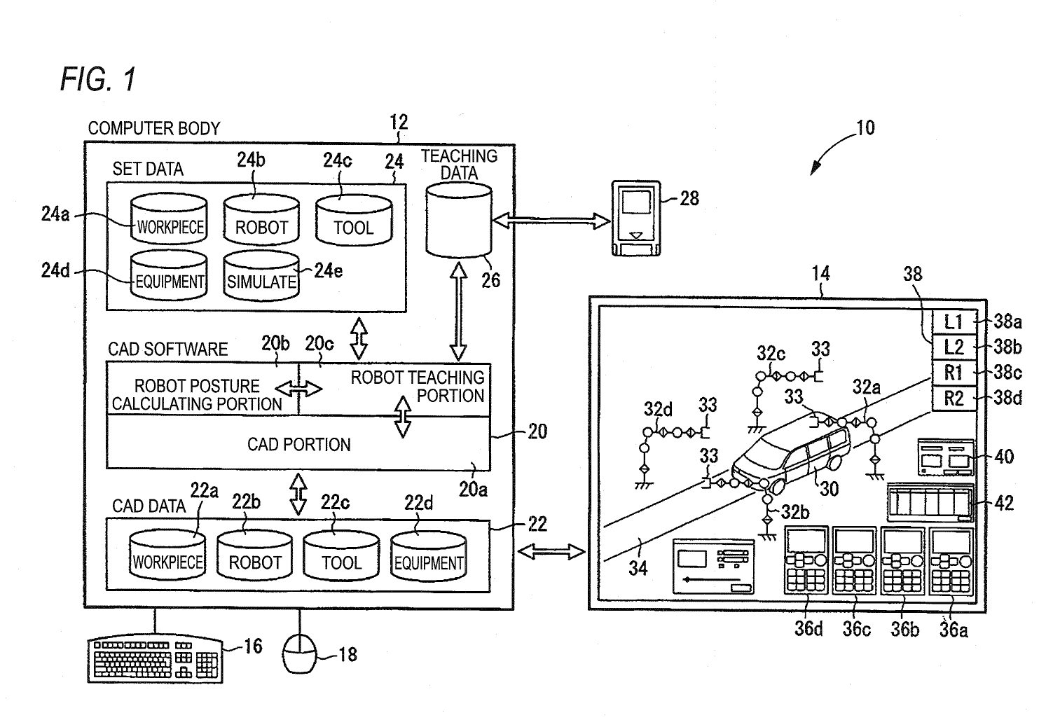

FIG. 1 shows a robot teaching device 10 using a robot off-line teaching method according to an embodiment of the invention. The robot teaching device 10 has a computer body 12, a monitor 14, a keyboard 16, and a mouse 18 serving as a pointing device.

The computer body 12 is a personal computer having CAD software 20, CAD data 22, set information 24 and teaching data 26, and a CPU (Central Processing Unit) serving as a main control portion reads and executes the CAD software 20 and generates, reads and edits the CAD data 22, the set information 24 and the teaching data 26. The teaching data 26 are freely read by a robot controller for controlling a robot (not shown) through a storage medium such as a PC card 28 or a communication.

It is assumed that four virtual robots 32a, 32b, 32c and 32d to be industrial articulated robots serve as targets to be taught by the robot teaching device 10 and a virtual vehicle 30 serves as a working target of the robot. Moreover, it is assumed that virtual equipment 34 such as a conveyor or a jig is provided in a station for carrying out a work with respect to the virtual vehicle 30. The virtual robots 32a and 32b are disposed on left sides of an upstream and a downstream of the conveyor respectively, and the virtual robots 32c and 32d are disposed on right sides of the upstream and the downstream of the conveyor. The four virtual robots 32a to 32d will be collectively referred to as a virtual robot 32.

The CAD data 22 are three-dimensional model data and have workpiece data 22a, robot data 22b, tool data 22c and equipment data 22d. The workpiece data 22a indicate the virtual vehicle 30 to be a workpiece, and the robot data 22b indicate the virtual robot 32 for carrying out a work with respect to the virtual vehicle 30. The tool data 22c indicate a tool 33 (an end effector) to be attached to a tip of the virtual robot 32, and the equipment data 22d indicate the associated equipment 34 in a production line or therearound. Referring to the tool 33, a different tool can also be attached for each virtual robot 32.

The workpiece data 22a, the robot data 22b, the tool data 22c and the equipment data 22d are not subjected to a data conversion but are exactly used in a CAD data format in each of processings for a display on the monitor 14, a coordinate conversion and an interference confirmation. Accordingly, it is possible to prevent a reduction in precision due to a conversion error, an occurrence of a defect of shape information and a deterioration in precision of a virtual teaching point which is generated. Furthermore, a time and labor is not required for a data converting work so that an efficiency can be enhanced.

The CAD software 20 serves to create and edit the CAD data 22 and to read the CAD data 22, thereby executing a predetermined processing, and has a CAD portion 20a, a robot posture calculating portion 20b (an attached program), and a robot teaching portion 20c (an attached program). The CAD portion 20a is a body part of the CAD software 20 and serves to generate and edit three-dimensional data and to carry out a display on the monitor 14. Although FIG. 1 typically shows the virtual robot 32, it is possible to actually display a realistic three-dimensional virtual robot 32 through a solid model by the CAD portion 20a.

The robot posture calculating portion 20b carries out inverse kinematics to calculate a displacement of each joint of the virtual robot 32 (a rotating displacement or a direct acting displacement) based on information about a virtual teaching point which is given, thereby generating posture data on the virtual robot 32. The information about the virtual teaching point includes information about a position and a posture of the virtual tool 33 as tip information about the virtual robot 32.

Moreover, the robot posture calculating portion 20b transmits, to the robot teaching portion 20c, the posture data on the virtual robot 32 which are generated if the same posture data are set into a movable range of the virtual robot 32, and transmits error data to the robot teaching portion 20c if the posture data are not included in a rotating range of the virtual robot 32 or there is a posture error such as a singular configuration. The robot teaching portion 20c displays the virtual robot 32 on a screen of the monitor 14 based on the posture data which are received.

The set information 24 is basic data for simulating a production process and has workpiece information 24a about the virtual vehicle 30, robot information 24b about the virtual robot 32 for carrying out a work with respect to the virtual vehicle 30, tool information 24c such as a welding gun or a coating gun which is additionally provided in the virtual robot 32, equipment information 24d related to the virtual equipment 34, and simulate information 24e indicative of various sets of a simulation.

A workpiece origin, a distance from the workpiece origin to a front end of a workpiece, a distance from the workpiece origin to a rear end of the workpiece, a machine type code, a derivative option and an option code are set to the workpiece information 24a.

A type of each joint of a robot, an angle of each joint in an initial posture of the robot, an operating range of each joint, a rotating direction of each joint, a moving speed range of each joint and a pulse rate of an axis of each joint are set to the robot information 24b.

Information about a position and a posture of the virtual tool 33 to be additionally provided on the virtual robot 32, a tool name, a tool number and a tool moving condition in a simulation are set to the tool information 24c.

An offset distance from a CAD origin to a conveyor origin, a distance from the conveyor origin to a conveyor pin, a distance from the conveyor origin to the workpiece origin, moving start and end positions of a conveyor, a speed of the conveyor, a conveyor synchronizing condition, a limit switch condition for taking a timing to carry out a synchronization with the conveyor and a distance from the CAD origin to a virtual robot origin are set to the equipment information 24d.

The number of the virtual robots 32 and a name and a number thereof, and the number of virtual conveyors and a name and a number thereof are set to the simulate information 24e.

A three-dimensional virtual space built in the CAD software 20 is displayed on the monitor 14, and the virtual vehicle 30 to be a target of a simulation operation, the virtual robot 32 which is additionally provided with the virtual tool 33, and the virtual equipment 34 are displayed on the monitor 14. Moreover, virtual teach pendants 36a, 36b, 36c and 36d corresponding to the virtual robots 32a to 32d and a robot list 38 are displayed. Hereinafter, the virtual teach pendants 36a to 36d will be typically referred to as a virtual teach pendant 36. The virtual teach pendant 36 is displayed as an image imitating a teach pendant which is actually provided on the robot.

The robot list 38 is provided with buttons 38a, 38b, 38c and 38d for specifying and indicating the virtual robots 32a to 32d, and they are displayed in a right and upper part of the screen of the monitor 14. The buttons 38a, 38b, 38c and 38d are displayed as “L1”, “L2”, “R1” and “R2” in order, respectively.

Furthermore, an interference confirmation dialog box 40 for setting an interference confirmation and an interference result dialog box 42 indicative of the result are displayed on the monitor 14 depending on a work. The dialog boxes can be displayed in an optional position on the screen of the monitor 14. The virtual teach pendant 36, the robot list 38 and the interference confirmation dialog box 40 can be manipulated through the mouse 18 or the keyboard 16.

The CAD portion 20a has a basic performance of a three-dimensional CAD and can change modeling or a layout. In addition, a straight line, a polygonal line, a curve or a coupling line thereof can be generated in an optional place of the virtual space. Furthermore, a ridge line of shape data on a workpiece model can be utilized for creating off-line teaching data.

An operator gives access to the CAD portion 20a from an outside through a DLL (Dynamic Link Library) or an IPC (Inter Process Communication) based on an external program so that a library of the CAD portion 20a (a plurality of programs) is operated. Consequently, it is possible to implement a simulation in the virtual space in the CAD software 20.

The IPC is a general software technique in which a data exchange is carried out between two programs which are being operated and the two programs may be thus present in the same system or network or between the networks, and the data exchange is executed through various unique protocols (communicating means). Moreover, the library of the CAD portion 20a represents a group of general-purpose functions, data or programs which can be used in plural software and is a general software technique.

The robot teaching portion 20c can operate each virtual model in the virtual space through the DLL or the IPC from the outside. Moreover, there are provided an equivalent manipulating function to a teach pendant of an actual machine robot and a UI (User Interface), and the virtual teach pendant 36 is displayed on the monitor 14 through a GUI (Graphical User Interface). Therefore, an excellent workability can be obtained.

The virtual teach pendant 36 has a function which is equivalent to that of an ordinary teach pendant for an actual machine (not shown), can define each axis of the virtual robot 32 and can allocate an input/output, and can register and edit the virtual teaching point, and furthermore, can register and edit a special instruction (a special command) such as an input/output command or a processing command. By manipulating the virtual teach pendant 36, moreover, it is possible to carry out a work for editing a moving command (a linear interpolation or a circular interpolation) on the virtual teaching point by operating the virtual robot 32 while properly changing an operating coordinate system of the virtual robot 32 (each axial pulse, each axial angle, a base coordinate, a tool coordinate, a working coordinate or an external axis) in the manipulation. In addition, the virtual teach pendant 36 can continuously carry out a predetermined operation at a low speed while a cursor button is pushed consecutively, and can move the virtual tool 33 at a predetermined speed in a predetermined direction, for example.

After the editing work through the virtual teach pendant 36 is completed, an actuation is confirmed through a manual operation and switching into an automatic operation is then carried out to actuate the virtual robot 32, and a confirmation of a single simulation (a simulation for one of the virtual robots 32 which is selected) or a composite simulation (a simultaneous simulation of a plurality of movable robots 32) is sequentially performed.

A single virtual teach pendant 36 is present for each virtual robot 32. When the robot name of the robot list 38 (that is, the button displayed as “L1”, “L2”, “R1” or “R2”) is clicked through the mouse 18, the virtual teach pendants 36 corresponding thereto are independently displayed on the screen of the monitor 14. Consequently, it is possible to easily confirm an execution of an instruction of the virtual robot 32 while seeing the display of the virtual teach pendant 36.

By making the most of advantages in the virtual space, furthermore, it is possible to freely stop and restart the single simulation and the composite simulation on the way. Moreover, it is possible to monitor a confirmation of an interference of virtual models and a clearance, a calculation of a cycle time of the virtual equipment 34, information about a position of each axis of the virtual robot 32 and information about an input/output. Therefore, a working efficiency can be enhanced.

Posture data on the virtual robot 32 or error data are transmitted from the robot posture calculating portion 20b to the robot teaching portion 20c so that the virtual robot 32 is operated on the virtual teaching point. In this case, when the virtual robot 32 interferes with the virtual attached equipment 34 or the virtual vehicle 30, the robot teaching portion 20c can directly refer to and use the CAD data 22 through the DLL or the IPC. Consequently, it is possible to confirm the interference with high precision by utilizing shape data on the three-dimensional virtual model.

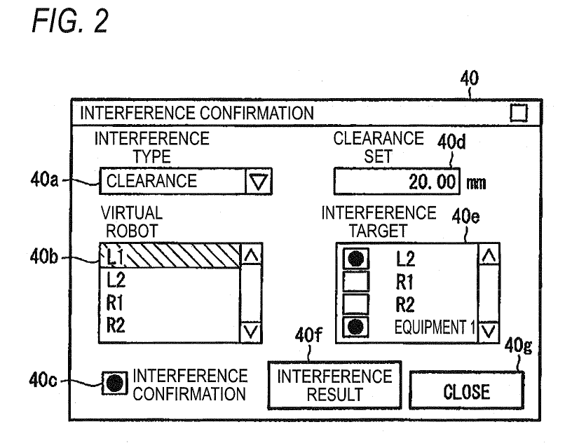

As shown in FIG. 2, the interference confirmation dialog box 40 has an interference type combo box 40a, a virtual robot list 40b, an interference confirmation check box 40c, a clearance setting editor 40d, an interference target list 40e, an interference result button 40f and a close button 40g.

An interference type is set by the interference type combo box 40a. When the virtual robot 32 is selected from the virtual robot list 40b, the interference target list 40e corresponding to the virtual robot 32 is displayed. The interference type is divided into “interference”, “contact” and “clearance”. The “interference” indicates the case in which the selected virtual robot 32 cuts into the virtual model, the “contact” indicates the case in which the selected virtual robot 32 comes in contact with the virtual model, and the “clearance” indicates the case in which the selected virtual robot 32 cannot ensure a predetermined clearance from a preset virtual model.

An interference target is checked and selected from the interference target list 40e and the interference confirmation check box 40c is turned ON or OFF to determine an execution of the interference confirmation. If the interference confirmation check box 40c is ON, the interference confirmation is executed so that an interference result of the interference result dialog box 42 can be confirmed. If the interference confirmation check box 40c is OFF, the interference confirmation is not executed. The interference result dialog box 42 is displayed by clicking the interference result button.

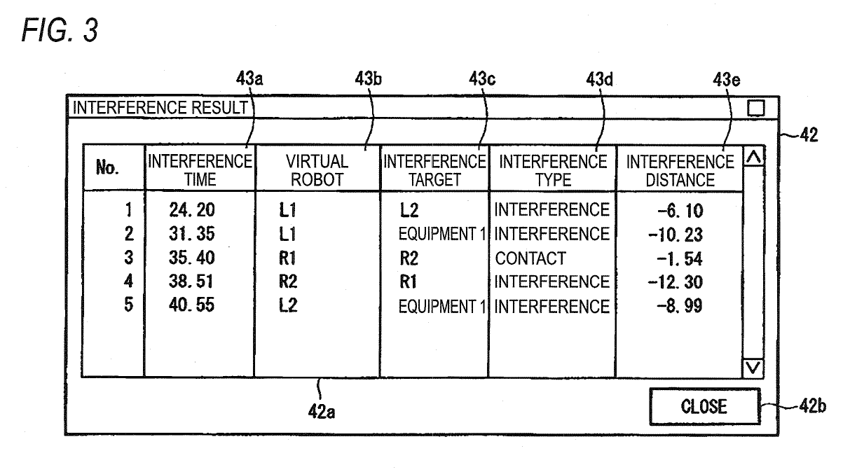

As shown in FIG. 3, the interference result dialog box 42 has a confirmation column 42a and a close button 42b. The confirmation column 42a is constituted by an interference time column 43a, a virtual robot column 43b, an interference target column 43c, an interference type column 43d, and an interference distance column 43e, and information about an interference is displayed in a correspondence of a single transverse line every occurrence of the interference. For example, in an uppermost line of the confirmation column 42a shown in FIG. 3, an “interference occurrence time” is 24.20 sec after a start, an “interference occurrence” is the virtual robot 32 corresponding to L1, and an “interference target” is the virtual robot 32 corresponding to L2. Moreover, an “interference type” is “interference” and an amount of cut-in is 6.10 mm.

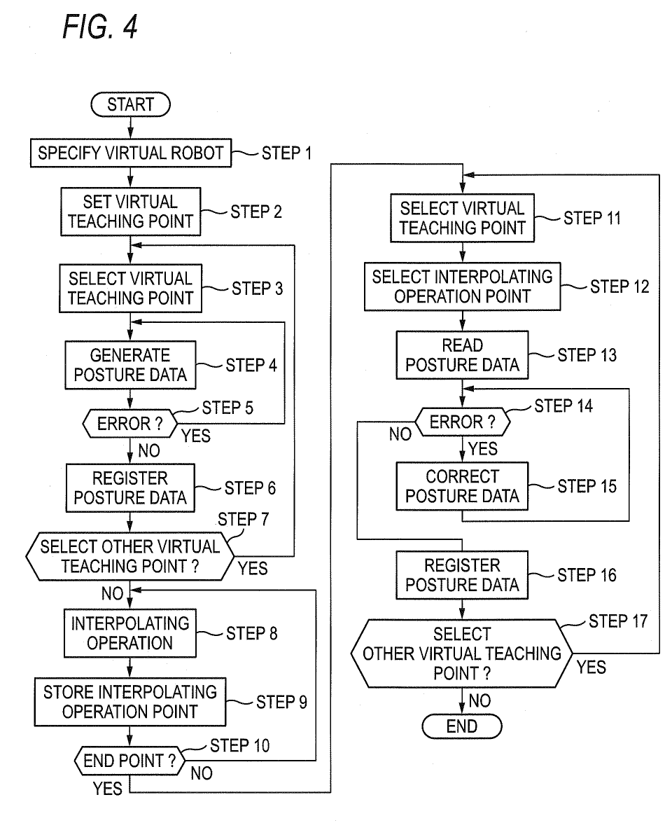

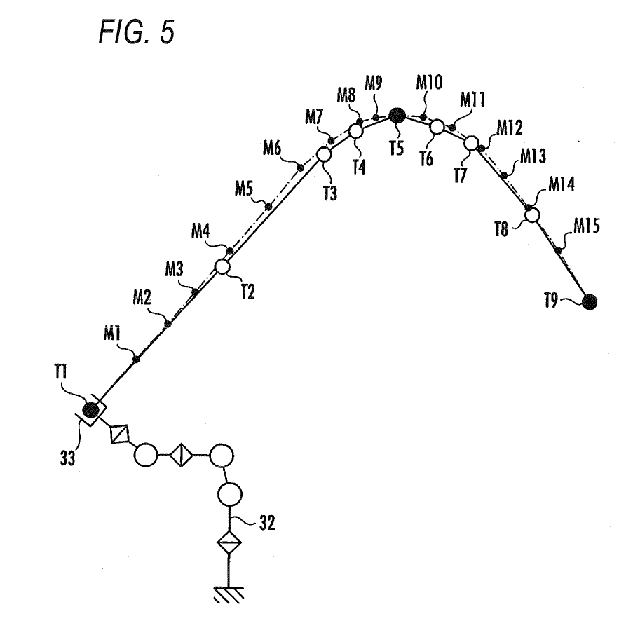

With reference to FIGS. 4 and 5, detailed description will be given to a robot off-line teaching method using the robot teaching CAD device 10 constituted as described above.

First of all, when a desirable robot name in the robot list 38 of the robot teaching portion 20c is clicked to specify one of the virtual robots 32 at STEP 1 in FIG. 4, the virtual teach pendant 36 corresponding thereto is displayed.

Then, the processing proceeds to STEP 2 in which the virtual teach pendant 36 is manipulated to set a plurality of virtual teaching points. For instance, as shown in an example of FIG. 5, nine virtual teaching points T1 to T9 are set. In FIG. 5, T1 corresponds to a start point and T9 corresponds to an end point. At this time, moreover, only coordinate information (position information) is registered and posture data on a virtual tool are not registered at each of the virtual teaching points.

Thereafter, the processing proceeds to STEP 3 in which one of the set virtual teaching points where the posture data are to be registered is selected. Subsequently, the processing proceeds to STEP 4 in which an operator manipulates the virtual teach pendant 36 to generate posture data on the virtual tool at the virtual teaching point selected in the STEP 3. The posture data are generated through an individual rotation of three axes of a coordinate system in the virtual tool by the virtual teach pendant 36 in order to cause the virtual tool to take a desirable posture.

Next, the processing proceeds to STEP 5 in which a presence of a posture error and an interference error is checked. If the error is present, it is displayed on the monitor 14, and furthermore, the processing returns to the STEP 4 to promote a correction of the posture data.

If there is no error at the STEP 5, the processing proceeds to STEP 6 in which the generated posture data are registered in the virtual teaching point specified at the STEP 3. Then, the processing proceeds to STEP 7 in which it is ascertained whether the posture data are registered at the other virtual teaching points or not. If the posture data are registered at the other virtual teaching points, the processing returns to the STEP 3 and the processings of the STEPs 3 to 6 are carried out again.

The virtual teaching points where the processings of the STPEs 3 to 6 are carried out correspond to “a part of the virtual teaching points” according to the invention, and the virtual teaching points where the processings of the STEPs 3 to 6 are not carried out correspond to “the other virtual teaching points excluding a part of the virtual teaching points”.

In the example of FIG. 5, the processings of the STEPs 3 to 6 are carried out over three virtual teaching points including the start point T1, the end point T9 and a corner point T5 in which a moving direction of the virtual tool 33 is greatly changed. More specifically, in the example shown in FIG. 5, the three virtual teaching points of T1, T5 and T9 correspond to “a part of the virtual teaching points” according to the invention and six virtual teaching points of T2 to T4 and T6 to T8 correspond to the “other virtual teaching points excluding a part of the virtual teaching points” according to the invention.

“A part of the virtual teaching points” according to the invention are not restricted to the three virtual teaching points illustrated in FIG. 5 but two virtual teaching points, that is, the start point and the end point may be set if there is no corner point, for example, and three virtual teaching points or more may be set if there is a plurality of corner points.

In a conventional CAD device, the processings of the STEPs 3 to 6 are carried out at all of the virtual teaching points. The posture data in the STEP 4 are generated through the individual rotation of the three axes constituting the coordinate system of the virtual tool by the virtual teach pendant 36 in order to cause the virtual tool to take a desirable posture. However, a great deal of labor is required for the work. For this reason, an enormous labor and time is required for generating teaching data in the conventional CAD device.

In the CAD device 10 according to the embodiment, processings of STEPs 8 to 17 are added to easily generate the posture data. This will be described below in detail.

If the posture data are not registered at the other virtual teaching points in the STEP 7, the processing proceeds to the STEP 8 in which only a part of the virtual teaching points where the posture data are registered are used to execute an interpolating operation between the virtual teaching points. In the interpolating operation, a processing for smoothly moving the virtual tool between the virtual teaching points is carried out in order to cause the virtual tool to take a registered posture at a part of the virtual teaching points where the posture data are registered.

In the interpolating operation, a coordinate (a position) and a posture of the virtual tool are calculated at a minimum calculating interval corresponding to a calculating capability of the CAD device 10. At the STEP 9, then, a result of the calculation is stored as an interpolating operation point. The processings of the STEPs 8 and 9 are executed from the start point to the endpoint of the virtual teaching point (STEP 10). Consequently, a plurality of interpolating operation points through the interpolating operation is generated.

In the example of FIG. 5, interpolating operation points of M1 to M15 are generated by the interpolating operation processings of the STEPs 8 to 10.

Thereafter, the processing proceeds to the STEP 11 in which there is selected the virtual teaching point where the posture data are not generated. Subsequently, the processing proceeds to the STEP 12 in which the interpolating operation point is displayed on a list (not shown) together with a distance from the virtual teaching point which is selected to the interpolating operation point based on a position coordinate of the virtual teaching point which is selected, and an interpolating operation point having a minimum distance is selected. Next, the processing proceeds to the STEP 13 in which posture data on the selected interpolating operation point are read. In other words, in the embodiment, “a predetermined selection criterion” according to the invention is set to be “an interpolating operation point positioned at a minimum distance from the selected virtual teaching point”.

Then, the processing proceeds to the STEP 14 in which there is checked a presence of a posture error and an interference error in the case in which the posture data on the interpolating operation point thus read are used as the posture data on the virtual teaching point selected at the STEP 11. If the error is present, the processing proceeds to the STEP 15 in which the posture data are corrected, and the processing thereafter returns to the STEP 14.

If the error is not present, the processing proceeds to the STEP 16 in which the generated posture data are registered as information about the selected virtual teaching point. Subsequently, the processing proceeds to the STEP 17 in which it is checked whether or not there is the other virtual teaching point where the posture data are not generated. If there is the virtual teaching point where the posture data are not generated, the processing returns to the STEP 11 in which there is selected the virtual teaching point where the posture data are not generated. If the posture data are generated on all of the virtual teaching points, the created data are stored as the teaching data 26 and the processing is ended.

The processings of the STEPs 11 to 17 will be described with reference to the example shown in FIG. 5. For example, in the case in which the virtual teaching point T2 is selected at the STEP 11, there is displayed the list (not shown) in which a distance to each interpolating operation point is displayed at the STEP 12. There is selected the interpolating operation point M4 having the shortest distance in the list. Next, posture data on the interpolating operation point M4 are read at the STEP 13. If there is no error at the STEP 14, the posture data on the interpolating operation point M4 are registered as the posture data on the virtual teaching point T2.

The same work is carried out for the virtual teaching points T3, T4 and T6 to T8 and data on the virtual teaching points which are created are stored as the teaching data 26, and the processing is ended.

After the virtual teaching points of all of the virtual robots 32 are completely registered, the single and composite simulations are sequentially executed to carry out an operating verification. If there is no problem, the virtual teaching points of all of the virtual robots 32 are stored as the teaching data 26 which are registered.

The teaching data 26 are stored as a file for each virtual teach pendant 36. In the case in which the teaching data 26 are transferred to a robot controller for controlling an actual machine robot, the teaching data 26 are converted into a robot controller readable format and are then transferred through the PC card 28 or a communication.

The virtual teaching point is displayed on the monitor 14 and an operator can easily confirm a position of the virtual teaching point. Moreover, the operator can also display the posture of the virtual robot 32 on the selected virtual teaching point by selecting the virtual teaching point through the mouse 18. Moreover, it is also possible to display a list of the virtual teaching point.

The processings of the STEPs 4 and 15 are carried out by the robot posture calculating portion 20b, and the other processings are carried out by the robot teaching portion 20c.

According to the robot teaching CAD device 10 in accordance with the embodiment, the posture data on the other virtual teaching points (T2 to T4 and T6 to T8 in the example of FIG. 5) excluding a part of the virtual teaching points are generated by copying the posture data included in the interpolating operation points (M4, M7, M8, M11, M12 and M14 in the example of FIG. 5) (the STEPs 11 to 17 in FIG. 4). Accordingly, it is not necessary to manually set the posture data at all of the virtual teaching points differently from the conventional art. Thus, the teaching data 26 for the robot can be created more easily in a shorter time than in the conventional art.

Moreover, the tip information about the virtual teaching point is set based on the information about the virtual vehicle 30 which is supplied from the CAD portion 20a through the robot teaching portion 20c capable of giving access to the CAD portion 20a. Therefore, the information about the virtual vehicle 30 can be exactly utilized without an execution of a data conversion, precision in the teaching for the virtual vehicle 30 can be enhanced, and furthermore, off-line teaching can be rapidly carried out. In particular, several hours are conventionally required for a work for transferring CAD data to a dedicated off-line teaching system. In the robot teaching CAD device 10, however, the time required for the data conversion is not taken and a total teaching time can be shortened.

In addition, the CAD system and the off-line teaching system can be aggregated. Therefore, it is possible to constitute an inexpensive device.

According to the structure, the posture data on the other virtual teaching points excluding a part of the virtual teaching points are generated by copying the posture data included in the interpolating operation point. Accordingly, it is not necessary to manually set the posture data on all of the virtual teaching points differently from the conventional art. Thus, it is possible to create teaching data for a robot in a shorter time than that in the conventional art.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. A robot off-line teaching method comprising:
setting a plurality of virtual teaching points at an interval from each other in order to teach a moving path and a posture of a virtual tool attached to a virtual robot in a manufacturing line on a virtual space;
setting a posture of the virtual tool on a part of the virtual teaching points which include at least a start point and an end point, respectively;
executing an interpolating operation between the part of the virtual teaching points in order to sequentially connect the part of the virtual teaching points from the start point to the end point and to take the posture of the virtual tool set at the part of the virtual teaching points, respectively;
storing a position and a posture of the virtual tool in the execution of the interpolating operation as an interpolating operation point every predetermined interval;
selecting any of the stored interpolating operation points which satisfies a predetermined selection criterion every other virtual teaching points excluding the part of the virtual teaching points; and
reading posture data on the selected interpolating operation point and storing the read posture data as posture data on the other virtual teaching points every other virtual teaching points.

2. The method according to claim 1, wherein
the predetermined selection criterion is the interpolating operation point positioned at a minimum distance from the other virtual teaching points.
